(19) United States
(12) Patent Application Publication
(10) Pub. No.: US 2017/0061512 A1
(43) Pub. Date: Mar. 2, 2017

(54) LOCATION BASED HELPME SYSTEM AND METHOD FOR REQUESTING AND RECEIVING ASSISTANCE

(71) Applicant: Sanem Avcil, Bahcesehir (TR)

(72) Inventor: Sanem Avcil, Bahcesehir (TR)

(21) Appl. No.: 15/248,984

(22) Filed: Aug. 26, 2016

Related U.S. Application Data
(60) Provisional application No. 62/210,109, filed on Aug. 26, 2015.

(51) Int. Cl. G06Q 30/06; G06Q 10/10; G06Q 20/10; H04W 4/02; G06Q 50/00

(52) U.S. Cl. CPC G06Q 30/0613; H04W 4/023; G06Q 50/01; G06Q 20/10; G06Q 10/1095; H04L 67/42

(57) ABSTRACT

A Location based HelpMe App. Users can find people who can help in their neighborhood or other designated geographic area. Helpers can make money for helping. People can search every kind of help on the Application. People can search who needs help within the area. People can search within a 0-10 KM Area (neighborhood) for the help. This will be IOS ANDROID WEB App Apple Watch App and Android Watch App, Windows and all the other platforms. Users can give reviews for helpers. There is 2 way communication. This application is location based.

### CROSS-REFERENCE TO RELATED APPLICATION

This application claims the benefit of priority of U.S. provisional application No. 62/210,109, filed Aug. 26, 2015, the contents of which are herein incorporated by reference.

### BACKGROUND OF THE INVENTION

The present invention relates to finding assistance with tasks to be performed, and more particularly to a location based system and method for matching a user who needs and requests assistance, with another user who is able to provide the requested assistance.

The system and method solves the problem of locating who needs help at home or office, or actually everybody in the neighborhood that is participating with one or more workers who are able to perform a service.

On other location based applications, a help app is missing for help for families and individuals.

As can be seen, there is a need for an improved system and method for pairing requesters who need assistance with helpers who can provide assistance.

### SUMMARY OF THE INVENTION

In one aspect of the present invention, a HelpMe system includes a server in communication a network and having a processor and a non-transitory computer readable storage media; wherein the server is configured to communicate with a plurality of mobile computing devices provisioned with a receiver to receive coordinate data from a satellite operating in earth orbit, a display, a user interface, and wireless communications with the network. The server is configured to receive a request for assistance entered by a requester via a user interface on the display of a first mobile computing device. The request for assistance includes coordinate data corresponding to a location of the requester and a description of the assistance required by said requester. The system may further have a payment module configured to receive a species of payment for the requested assistance from the requester.

The server is configured to communicate the request for assistance via the network to a second mobile computing device corresponding to one or more helpers selected based on location data for the second mobile computing device received by said server.

The server is configured to communicate an offer of assistance, entered by the helper via a user interface on the display of the second mobile computing device, where the offer of assistance includes coordinate data corresponding to a geographic location of the helper.

A scheduling module is configured for the requester and the helper to schedule a performance a task specified in the request. The scheduling module may also be configured to receive a start signal from the second mobile computing device indicating the helper's beginning of the task and the start signal is transmitted to the first mobile computing device. The scheduling module may also be configured to receive a completed signal from the second mobile computing device indicating the helper's completion of the task and transmits the completion signal is to the first mobile computing device. The payment module is further configured to communicate the species of payment to the helper upon completion of the task.

The system may also include a review module configured to receive a review from the requester, the review providing one or more indicia of the helper's performance of the task. A profile module may also be configured to present a helper profile, including an identification indicia of the helper. The review module is configured to update the helper profile based on the review.

In other aspects of the invention, a system for coordinating assistance, includes: a computer having a processor and in communication with a network; a program product comprising machine-readable program code for causing, when executed, the computer to perform the following process steps: receiving a request for assistance entered by a requester via a user interface on the display of a first mobile computing device, the request for assistance including coordinate data corresponding to a location of the requester and a description of the assistance required by said requester; communicating the request for assistance via a network to a second mobile computing device corresponding to a helper selected based on location data for the helper received by the server; and receiving an offer of assistance from the second mobile computing device, wherein the offer of assistance includes coordinate data corresponding to a geographic location of the helper.

These and other features, aspects and advantages of the present invention will become better understood with reference to the following drawings, description and claims.

### BRIEF DESCRIPTION OF THE DRAWINGS

FIG. 1 is a flowchart presenting aspects of a system according to the present the invention.

FIG. 2 is a mobile device showing a representative graphical user interface (GUI) display for a menu screen.

FIG. 3 is the mobile device showing a “Who wants help” GUI screen display.

FIG. 4 is the mobile device showing the “Who will help” GUI selection screen display.

### DETAILED DESCRIPTION OF THE INVENTION

Broadly, an embodiment of the present invention provides a location based system and method for matching a user who needs and requests assistance, a requester, with another user who is able to provide the requested assistance, a helper.

Preferably, the requester and helper are located within a nearby designated area, which can be the same neighborhood or globally for digital help. The extent of the area can be a small city or a neighborhood, which may include, for example an area of between about 0-30 KM. The system includes location based awareness technologies, which utilizes, for example, Google's SDK for generating maps and for finding locations.

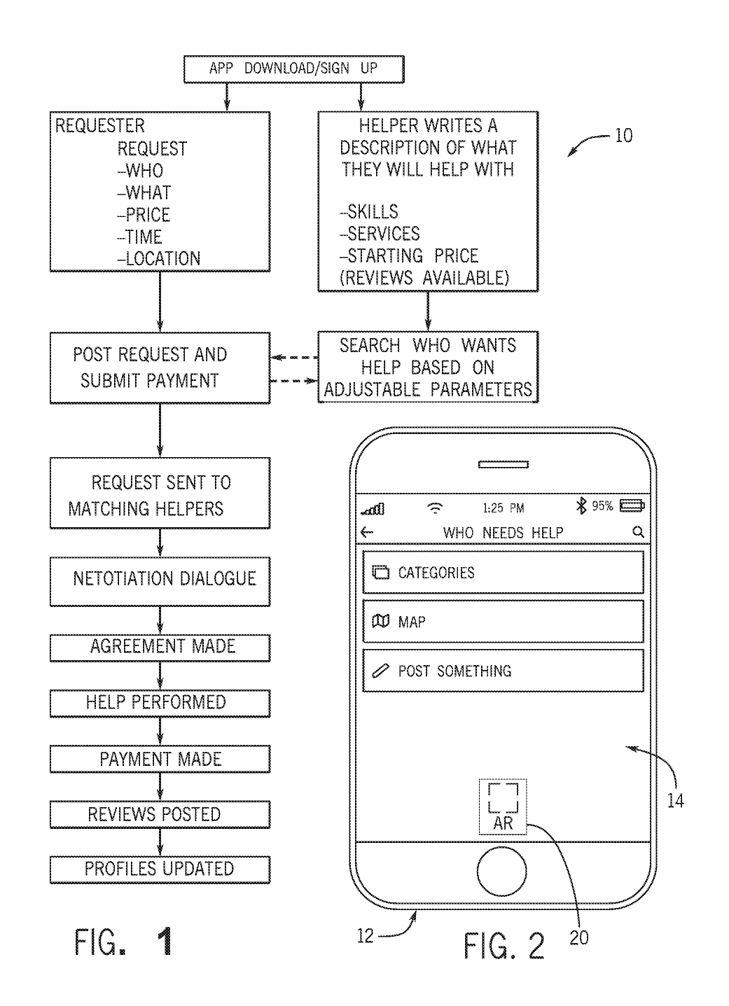

As seen in reference to FIG. 1, a requester and a helper may download an application and sign up with the system 10. In a preferred embodiment, the location SDK is utilized for pairing the requester, with the helper who has indicated a willingness to work within a specified geographic area. When the requester needs help, the system may be configured to execute a search for assistance within a specified geographic area, so the helper can come and render the requested assistance immediately, or be available within the specified time period in designated in the request. The requester may enter a request for assistance via an I need help module, via the GUI on the mobile computing device 12 application, where the request can indicate basic information concerning the assistance required, such as: a requester's identification, the type of assistance they need, the price they may be willing to pay, the time they may deed the assistance, and the location where the services are needed.

The requester can even be in an unknown neighborhood, as may be required, for example, when the requester's vehicle has an unexpected breakdown. For example, in 0-15 KM area, helpers can find the requester with this system and through the system, and indicate their ability to help the requester. As will be appreciated, the requester does not need to be in a specific area. Wherever the requester may go, the system will search the area that the requester is presently located.

After the requester has completed the information for the assistance needed, the requester then posts the request to the system and pays for the services requested. Rather than exchanging consideration or payment for the assistance at the point of performance, the system has a payment module for the requester to pay in advance for the services provided by the helper. The requester can pay by credit card, Pay-Pal, or by telephone or coupons that may be created by the system. The system will retain the payments until the task has been completed, in which case the system makes payment to the helper. If requester makes direct payment to the helper or a helper demands additional direct payment from the requester, they can be excluded from the system.

Once the request has been posted, the system processes the requests via an Who Needs Help Module to make the request available for viewing to one or more helpers meeting the parameters specified in the request. As seen in reference to FIG. 2, a helper may utilize the system of the present invention through a GUI, which includes a menu 14 presented on the display of a mobile computing device 12. The GUI menu 14 may provide a menu banner indicating a “Who Needs Help” alert. The GUI may present a geolocation representation, such as a map, for the helper's present location and one or more icons or other indicia on the display indicating one or more requesters in geographic proximity to the helper who are requesting assistance. The helper may then select one of the request icons and indicate their willingness to perform the requested task and may be provided the opportunity to enter a bid for the task, via an I Will Help Module.

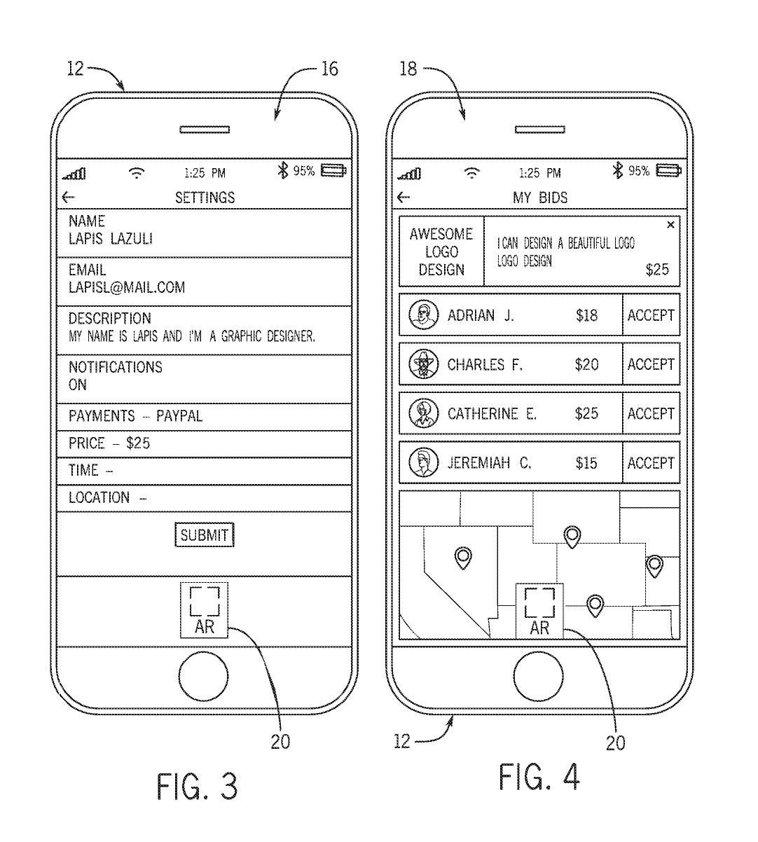

The I Will Help Module may also be configured for helpers to post their willingness or abilities to help via a GUI 16 on their mobile computing device 12, such as shown in reference to FIG. 3. For example, the helper may indicate their skills, services they can perform, and a cost structure for their services. These are available for searching by a requester or other users of the system 10. The system may also update the helper's page with the results of one or more reviews they received on completion of a previous task.

The requester may be presented with a Who Will Help GUI 18, such as shown in reference to FIG. 4, listing the one or more helpers who have submitted an offer to assist and perform the task. The GUI may present identification information for the helper, such as a name a photographic image of the helper. The image will assist the requester in identifying the helper as the one who was actually selected to perform the work. The GUI may also present geo location indicia for the respective helpers, to assist the requester in making their selection. The GUI may also incorporate an augmented reality 20 area, which may overlay a graphical icon of the helper's location, with a view of an area captured through a camera on the requester's. This may assist the requester in locating the designated helper, for example at particular location of a mall or a market.

Through the system Scheduling Module, the requester and the helper can contract for the assistance. The system may further include a chat system that the requester and helper can utilize to contact each other via a negotiation dialogue, for example to provide more detailed instructions regarding a task or to agree upon the terms of the task to be performed. Once the parties have agreed upon the terms, the Scheduling Module provides an opportunity for the helper to indicate that they have started the task, which is communicated to the requester, via the System Scheduling Module. The helper may also communicate the completion of the task by selection of a Job Done control, wherein the system signals the completion of the task to the requester's mobile communications device 10.

The system may also be configured with a Review Module. In the Review Module, the requester can submit a rating of the helper in one or more categories, such as communications with the helper, services performed, and a recommendation of whether the requester would use the helper again or recommend them to others.

For each user's security the system will record and monitor when these jobs are started and when they finished. For the requester, the system will confirm and monitor that the helper is at the designated work location to perform the work. For the helper, the system will monitor their work performance, and if they didn't complete the job will within a specified time parameter, the system may be able to determine whether something is wrong at the worksite. In order to secure people if the job didn't finish on time, the system may present an indication if there is potentially something wrong in that site.

The system is also amenable to operations in big factories. In this case, factory workers can use the whenever they are in need of help in order to reach the designated workers for performing such tasks.

The App may be configured to open 2 basic modules, one for people who want help, a requester, and one for people who will assist or perform a task, a helper. For the helpers, when a helper clicks who wants help they will see people on avatar or by ads. When they click inside these the helper will be able to go and see who wants help in their neighborhood. Also users can search for those individuals who may need help in the neighborhood or who can help in the neighborhood. When somebody needs help in the neighborhood everybody who has the app may get a notification. When somebody is willing to help for some specific thing, then everybody will get notification from a cloud based server from the application via a push Notification. The system may also be configured for requesters to follow helpers so they can check on the progress of the helper in carrying out their task.

According to an aspect of the invention, the system operator will get a commission for the services provided through the system, for example for 5 dollars we will get 1 dollars for that. If people cancel they will refund by system. People can register with their social media accounts. People can search who needs help or who they can help and get money. People can search for an individuals what they can do for themselves. People can chat about their problems on the app. They can schedule the time for helping each other. People can find some custom created helps. Helpers can create some custom helps.

It's really easy for requesters to solve their problem because the system will connect them with helpers will solve the problems immediately. People will be joined like this and can collaborate within their neighborhood. There will not be a problem in the neighborhood anymore. Or there will not be a person in the neighborhood who can't fix some or perform services. Using this invention will be easy. When someone click on the app they will search for the helpers or they will search people who can help. They only need internet connection a computer or a smart cell phone, a smart watch. Than it will work.

Other sectors in the neighborhood can use the system, for example the owner of a local computer repair shop. The owner can utilize the system's Who Wants Help Module to search for or receive notification of opportunities to render assistance as a helper. In this case the shopper will be helper and will receive the messages from app for those who need computer help right now.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system comprising:
a server in communication a network and having a processor and a non-transitory computer readable storage media; the server configured to communicate with a plurality of mobile computing devices provisioned with a receiver to receive coordinate data from a satellite operating in earth orbit, a display, a user interface, and wireless communications with the network;
wherein said server receives a request for assistance entered by a requester via a user interface on the display of a first mobile computing device, said request for assistance comprising coordinate data corresponding to a location of said requester and a description of the assistance required by said requester.

2. The system of claim 1, further comprising:
a payment module configured to receive a species of payment for the requested assistance from the requester.

3. The system of claim 2, wherein said server communicates said request for assistance via said network to one or more second mobile computing devices corresponding to one or more helpers selected based on location data for said other user received by said server.

4. The system of claim 3, wherein said server communicates an offer of assistance, entered by said helper via a user interface on the display of said second mobile computing device; said offer of assistance comprising coordinate data corresponding to a geographic location of said helper.

5. The system of claim 4, wherein said server further comprises:
a scheduling module configured for the requester and the helper to schedule a performance a task specified in the request.

6. The system of claim 5, wherein the scheduling module is configured to receive a start signal from the second mobile computing device indicating the helper's beginning of the task, and the start signal is transmitted to the first mobile computing device.

7. The system of claim 6, wherein the scheduling module is configured to receive a completed signal from the second mobile computing device indicating the helper's completion of the task and transmit the completion signal is to the first mobile computing device.

8. The system of claim 7, wherein the payment module is further configured to communicate the species of payment to the helper upon completion of the task.

9. The system of claim 8, further comprising:
a review module configured to receive a review from the requester, the review providing one or more indicia of the helper's performance of the task.

10. The system of claim 9, further comprising:
a profile module configured to present a helper profile, including an identification indicia of the helper.

11. The system of claim 10, wherein the review module is configured to update the helper profile based on the review.

12. A system for coordinating assistance, comprising:
a computer having a processor and in communication with a network; and
a program product comprising machine-readable program code for causing, when executed, the computer to perform the following process steps:
receiving a request for assistance entered by a requester via a user interface on the display of a first mobile computing device, said request for assistance comprising coordinate data corresponding to a location of said requester and a description of the assistance required by said requester;
communicating said request for assistance via a network to one or more second mobile computing devices corresponding to one or more helpers selected based on location data for said helper received by said server; and
receiving an offer of assistance from the one or more second mobile computing devices, wherein said offer of assistance comprising coordinate data corresponding to a geographic location of said helper.
